(19) United States
(12) Patent Application Publication
(10) Pub. No.: US 2013/0063258 A1
(43) Pub. Date: Mar. 14, 2013

(54) ELECTRIC MOVING BODY ALARM SOUND CONTROL DEVICE

(71) Applicants: Tatsuya Mitsugi, Tokyo (JP); Satoru Inoue, Tokyo (JP); Takahisa Aoyagi, Tokyo (JP)

(72) Inventors: Tatsuya Mitsugi, Tokyo (JP); Satoru Inoue, Tokyo (JP); Takahisa Aoyagi, Tokyo (JP)

(73) Assignee: MITSUBISHI ELECTRIC CORPORATION, Tokyo (JP)

(21) Appl. No.: 13/696,160

(22) PCT Filed: Aug. 16, 2010
(86) PCT No.: PCT/JP2010/063819

§ 371 Date: Nov. 5, 2012

(51) Int. Cl. B60Q 5/00

(52) U.S. Cl. 340/463

(57) ABSTRACT

An electric moving body alarm sound control device that does not generate alarm sound more than necessary nor less than necessary is provided in electric moving bodies, such as hybrid vehicles and electric vehicles, excellent in quietness. An electric moving body alarm sound control device comprises an electric moving body noise detection unit that detects noise the electric moving body generates by itself; an electric moving body noise level comparison determination unit that determines the noise level the electric moving body generates, based on the detection signal detected by the electric moving body noise detection unit; and an alarm sound volume level control unit that takes control of the volume level of alarm sound a sound-emitting unit emits, based on the determination result by the electric moving body noise level comparison determination unit.

### TECHNICAL FIELD

The present invention relates to an electric moving body alarm sound control device that is equipped with an alarm sound generation mechanism for telling its approaching to nearby pedestrians etc., in electric moving bodies, such as hybrid vehicles and electric vehicles, excellent in quietness.

### BACKGROUND ART

Following the practical development of electric bicycles and carts in recent years, transportation means serving as various kinds of moving bodies, such as electric motorcycles and electric vehicles, have been powered by electricity. Specifically, as the replacement of motor vehicles powered by internal combustion engines, there have been developed one after another vehicles such as hybrid vehicles powered by both gasoline engines and electric motors, electric vehicles powered by electric motors driven by onboard batteries that are recharged by power sources for household use and battery chargers installed at gas stations, power supply stations, etc., and fuel cell vehicles that run while generating electricity by fuel cells using hydrogen and the like as the fuel. Some of those hybrid vehicles and electric vehicles have already been put into practical use and begun becoming widespread.

Since gasoline vehicles, diesel vehicles, etc. powered by the conventional internal combustion engines generate not only engine exhaust sound their power sources emit but also road noise and the like in running, pedestrians going around town streets, cyclists, etc. can recognize those vehicles approaching by their engine and exhaust sound and the like. However, when running at low speed, the hybrid vehicles do not run powered by the combustion engines, but go into a running mode powered by the electric motors; therefore, engine and exhaust sound and the like are not generated, and furthermore, as to the electric vehicles and fuel cell vehicles, they even run driven by the electric motors over the whole operation range, which has made both vehicles particularly quiet electric moving bodies. However, pedestrians, cyclists, etc. who are in the vicinity of such quiet electric moving bodies as above cannot recognize by sound the approaching of the electric moving bodies, such as hybrid vehicles, electric vehicles and fuel cell vehicles, running driven by the electric motors that generate little sound and excel in quietness, which therefore might cause occurrence of accidental contact of the pedestrians etc. with those electric moving bodies excellent in quietness.

Therefore, in order to aim at solving the foregoing problem in that quietness, which should be the advantage inherent to the hybrid vehicles, electric vehicles and fuel cell vehicles, sometimes become harmful, there have been proposed various systems, other than klaxons mounted on conventional vehicles and operating following drivers' intention, that operate independently of the drivers' intention and give an alarm about the presence of the vehicles' own.

For example, a technology has been disclosed in Patent Document 1, in which a vehicle includes a running ambience determination means that determines a running ambience surrounding the vehicle, and determines, as the running ambience, a running area, running time of the day, brightness around the running area, and the volume of sound outside the vehicle when running, whereby the vehicle chooses an alarming means by sound depending on the running ambience, or when determining that an alarm means by sound is ineffective, the vehicle does not choose the alarming means by sound, but chooses an alarming means by light, for example, to give an alarm about the presence of its own.

Moreover, an alarm system has been disclosed in Patent Document 2, which includes a determination means that determines timing at which a vehicle gives an alarm about the presence of the vehicle's own to the vicinity of the vehicle, and an output means that emits outside the vehicle (particularly forward of the vehicle) a predetermined acoustic signal on which predetermined noise is superimposed (vehicle-approach-telling sound for telling vehicle's approaching) so as to cause a stochastic resonance phenomenon, when the determination means determines that it is the timing of giving the alarm about the presence of its own to the vicinity thereof.

In addition, a technology and others have been disclosed in Patent Document 3, in which an alarm system includes an object detection unit and vehicle speed detection unit, and when an object is detected, varies an angular range of sound emitted from an alarm unit that emits sound forward depending on the detected vehicle speed, and in which sound by a musical box is utilized as the alarm sound.

Furthermore, in Patent Document 4 are disclosed a technology in which an alarm system includes an object sensor that detects an object in the vicinity of a vehicle, and when an object is detected, takes control of an electric drive system of the vehicle so that sound generated by a drive source constituting the electric drive system becomes alarm sound, and another technology in which an alarm system, for the purpose of controlling the volume of generation sound, takes controls of such as increasing torque ripple of the motor, setting audible range of the frequency of a PWM carrier signal, continuously varying the frequency of the PWM carrier signal, and increasing rotation speed of a pump for discharging coolant to cool heat-generating parts, whereby pedestrians etc. in the vicinity are enabled to easily recognize the alarm sound.

### PRIOR ART DOCUMENT

### Patent Document

Patent Document 1: Japanese Laid-open Patent Publication No. 2005-255091
Patent Document 2: Japanese Laid-open Patent Publication No. 2007-203924
Patent document 3: Japanese Laid-open Patent Publication No. H7-209424
Patent document 4: Japanese Laid-open Patent Publication No. 2005-254935

### DISCLOSURE OF THE INVENTION

### Problem to be Solved by the Invention

Alarm systems to enable pedestrians etc. to recognize the presence of an electric moving body are configured as described above, and there have been proposed a variety of technologies to take control of alarm sound and the like depending on the ambience surrounding the electric moving body or the status of its own; in particular, however, in taking control of the alarm sound, the alarm systems do not take control in such a way as to generate suitable alarm sound by detecting the noise level the electric moving body actually generates; therefore, the alarm sound has been likely to be emitted more than necessary, or less than necessary.

The present invention has been made to aim at solving the foregoing problem, and providing an electric moving body alarm sound control device in which the volume level of alarm sound is controlled depending on the noise level the electric moving body actually generates, so that the alarm sound is not likely to be generated more than necessary nor less than necessary.

### Means for Solving the Problem

An electric moving body alarm sound control device according to the present invention comprises an electric moving body noise detection unit that detects noise an electric moving body generates by itself; an electric moving body noise level comparison determination unit that determines the noise level the electric moving body generates, based on the detection signal detected by the electric moving body noise detection unit; and an alarm sound volume level control unit that takes control of the volume level of alarm sound a sound-emitting unit emits, based on the determination result by the electric moving body noise level comparison determination unit.

### Advantage of the Invention

According to the present invention, an electric moving body alarm sound control device can be provided, in which noise the electric moving body generates by itself is detected, and the volume of alarm sound is controlled based on the detected noise level; therefore, the alarm sound is not likely to be generated more than necessary nor less than necessary.

### BRIEF DESCRIPTION OF THE DRAWINGS

FIG. 1 is a block diagram showing a general configuration of an electric moving body alarm sound control device according to Embodiment 1 of the present invention;

FIG. 2 is a schematic diagram showing in part an essential part of the electric moving body alarm sound control device according to Embodiment 1 of the present invention;

FIG. 3 is a block diagram showing a configurational example of an electric moving body noise detection unit of the electric moving body alarm sound control device according to Embodiment 1 of the present invention;

FIG. 4 is a block diagram showing a general configuration of an electric moving body alarm sound control device according to Embodiment 2 of the present invention;

FIG. 5 is a block diagram showing a configurational example of an ambient noise detection unit of the electric moving body alarm sound control device according to Embodiment 2 of the present invention;

FIG. 6 is a block diagram showing a general configuration of an essential part of an electric moving body alarm sound control device according to Embodiment 3 of the present invention;

FIG. 7 is a block diagram showing a general configuration of an electric moving body noise detection unit of an electric moving body alarm sound control device according to Embodiment 4 of the present invention;

FIG. 8 is a block diagram showing a general configuration of an electric moving body noise detection unit of an electric moving body alarm sound control device according to Embodiment 5 of the present invention;

FIG. 9 is a block diagram showing a general configuration of an ambient noise detection unit of the electric moving body alarm sound control device according to Embodiment 5 of the present invention;

FIG. 10 is a block diagram showing a general configuration of an electric moving body alarm sound control device according to Embodiment 6 of the present invention;

FIG. 11 is a block diagram showing a general configuration of another electric moving body alarm sound control device according to Embodiment 6 of the present invention;

FIG. 12 is a block diagram showing a general configuration of an essential part of an electric moving body alarm sound control device according to Embodiment 7 of the present invention;

FIG. 13 is a block diagram showing a general configuration of an essential part of an electric moving body alarm sound control device according to Embodiment 8 of the present invention;

FIG. 14 is a block diagram showing a general configuration of an essential part of an electric moving body alarm sound control device according to Embodiment 9 of the present invention; and

FIG. 15 is a block diagram showing a general configuration of an essential part of an electric moving body alarm sound control device according to Embodiment 10 of the present invention.

### EMBODIMENTS FOR CARRYING OUT THE INVENTION

### Embodiment 1

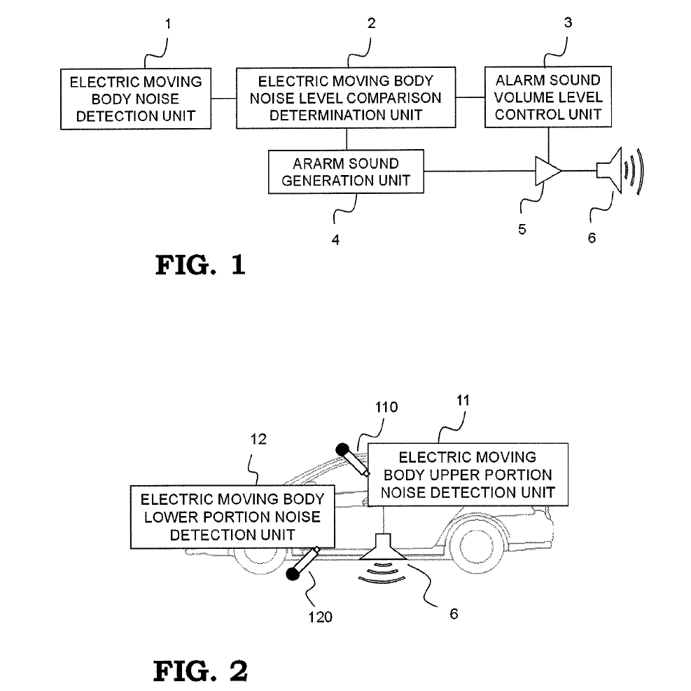

FIG. 1 is a block diagram showing a general configuration of an electric moving body alarm sound control device according to Embodiment 1 of the present invention. First of all, an electric moving body noise detection unit 1 detects a sound level generated by the electric moving body itself such as an electric vehicle or hybrid vehicle. An electric moving body noise level comparison determination unit 2 determines the noise level that is generated by the electric moving body itself and detected by the electric moving body noise detection unit 1, and enables an alarm sound generation unit 4 to generate alarm sound based on the determination result, and in addition, an alarm sound volume level control unit 3 takes control of the gain of an alarm sound amplifier 5, so as to take control of the alarm sound level generated by a sound-emitting unit 6 including a speaker. The sound-emitting unit 6 is a speaker, for example, but not limited to a so-called speaker as long as it is a sound-emitting unit whose sound volume and the like are controllable.

The method of controlling is as follows: for example, when the electric moving body noise level comparison determination unit 2 determines that the noise level generated by the electric moving body itself is lower than a predetermined level, the gain of the alarm sound amplifier 5 is controlled in such a way that the noise level generated by the whole electric moving body, in which the alarm sound the sound-emitting unit 6 emits is added to the noise the electric moving body generates by itself, exceeds the predetermined level.

Next, a configurational example of the electric moving body noise detection unit 1 will be described. First of all, as shown in FIG. 2, an electric moving body upper portion noise detection unit 11 is provided that detects noise in the upper portion of the electric moving body by a vehicle upper portion noise detector 110, such as a microphone, that is installed at an upper position of the electric moving body and outputs the detection signal. The microphone, which is the vehicle upper portion noise detector 110, is installed so as to collect noise outside the ceiling of the electric moving body. Moreover, at a lower position of the electric moving body is also installed a vehicle lower portion noise detector 120, such as a microphone, that collects noise, and an electric moving body lower portion noise detection unit 12 is provided to thereby detect noise in the lower portion of the electric moving body and output the detection signal.

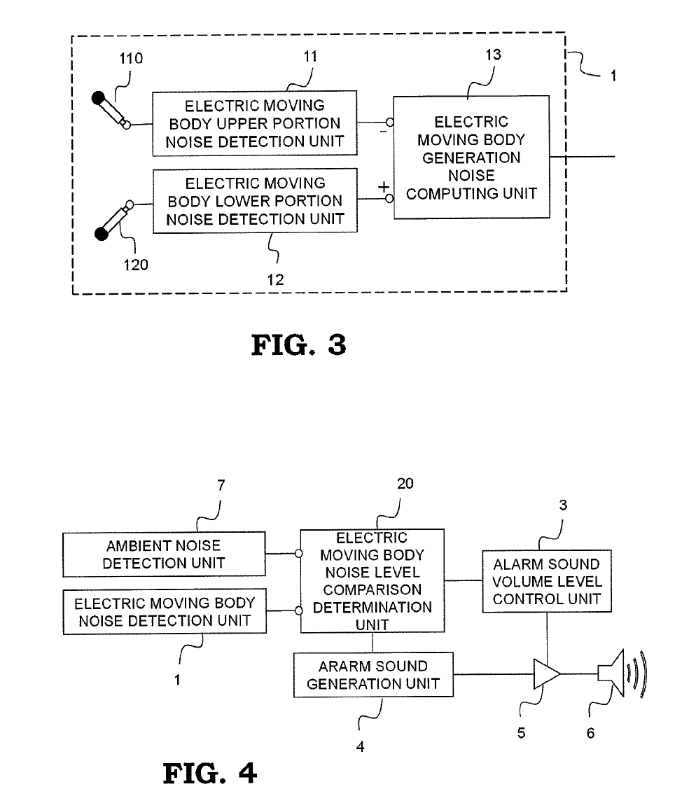

The detection signal detected by the electric moving body lower portion noise detection unit 12 is for the most part noise the electric moving body generates by itself, and includes in part noise in the ambience surrounding the electric moving body. Moreover, the detection signal detected by the electric moving body upper portion noise detection unit 11 is for the most part the noise in the ambience surrounding the electric moving body, and includes in part the noise the electric moving body generates by itself. Thus as shown in FIG. 3, the electric moving body noise detection unit 1 shown in FIG. 1 is configured by providing it with an electric moving body generation noise computing unit 13 that computes the noise the electric moving body generates by itself, from the detection signal detected by the electric moving body lower portion noise detection unit 12 and that detected by the electric moving body upper portion noise detection unit 11.

By configuring as described above, when the volume level of noise the electric moving body generates by itself is lower than the predetermined volume level, it is presumed that pedestrians etc. in the vicinity thereof are likely to miss the moving body; by adding the alarm sound, the overall sound volume the electric moving body generates is increased to greater than the predetermined volume, so that pedestrians etc. in the vicinity are enabled to recognize the presence of the electric moving body. Meanwhile, when the volume of noise the electric moving body generates by itself exceeds the predetermined volume, it is presumed the pedestrians etc. in the vicinity can recognize the presence of the electric moving body only by the noise the electric moving body generates by itself, and generation of the alarm sound is stopped, so that the alarm sound can be prevented from causing adverse effect on the ambient noise.

### Embodiment 2

FIG. 4 is a block diagram showing a general configuration of an electric moving body alarm sound control device according to Embodiment 2 of the present invention. In FIG. 4, the same reference numerals as those in FIG. 1 represent the same or corresponding parts. As shown in FIG. 4, the electric moving body noise detection unit 1 detects noise the electric moving body generates by itself, and in addition, an ambient noise detection unit 7 detects noise generated in the ambience surrounding the electric moving body. An electric moving body noise level comparison determination unit 20 determines the volume level of noise the electric moving body generates by itself and that of noise generated in the ambience surrounding the electric moving body, to allow the alarm sound generation unit 4 to generate alarm sound, and in addition, the alarm sound volume level control unit 3 takes control of the gain of the alarm sound amplifier 5, so as to adjust the level of alarm sound generated by the sound-emitting unit 6 including a speaker.

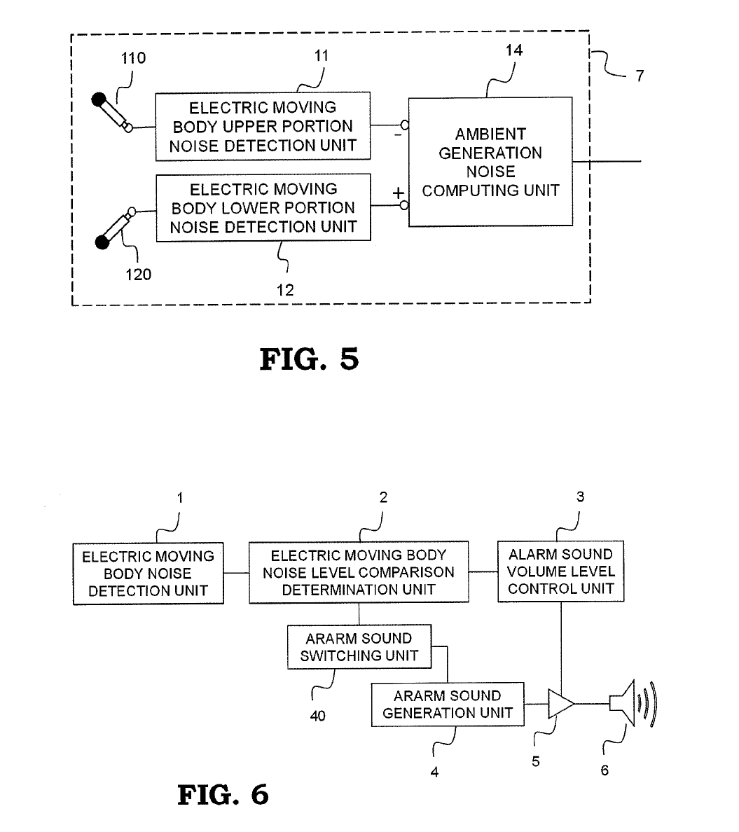

The configuration of the electric moving body noise detection unit 1 is, for example, the one shown in FIG. 3 as explained in Embodiment 1, by which the noise the electric moving body generates by itself is detected. Moreover, a configurational example of the ambient noise detection unit 7 is shown in FIG. 5. As has been explained in Embodiment 1, the detection signal detected by the electric moving body lower portion noise detection unit 12 is for the most part the noise the electric moving body generates by itself, and includes in part the noise in the ambience surrounding the electric moving body. Furthermore, the detection signal detected by the electric moving body upper portion noise detection unit 11 is for the most part the noise in the ambience surrounding the electric moving body, and includes in part the noise the electric moving body generates by itself. So the ambient noise detection unit 7 shown in FIG. 4 is configured as shown in FIG. 5, by providing it with an ambient generation noise computing unit 14 that computes the noise generated in the ambience, from the detection signal detected by the electric moving body upper portion noise detection unit 11 and that detected by the electric moving body lower portion noise detection unit 12.

By configuring as described above, when sound volume difference between the volume of noise the electric moving body generates and the volume of noise generated in the ambience surrounding the electric moving body is less than a first predetermined volume, it is presumed that pedestrians etc. in the vicinity thereof are likely to miss the presence of the electric moving body. By adding the alarm sound, the sound volume difference between the volume of noise the electric moving body generates as a whole and volume of noise generated in the ambience surrounding the electric moving body is increased to greater than the predetermined volume, thereby enabling pedestrians etc. in the vicinity to recognize the presence of the electric moving body.

Moreover, when the sound volume difference between the volume of noise the electric moving body generates and volume of noise generated in the ambience surrounding the electric moving body is greater than the first predetermined volume, it is presumed that pedestrians etc. in the vicinity can recognize the presence of the electric moving body, so generation of the alarm sound is stopped, so that the alarm sound is prevented from causing adverse effect on the ambient noise.

Furthermore, when the sound volume difference between the volume of noise the electric moving body generates and volume of noise generated in the ambience surrounding the electric moving body is greater than a second predetermined volume, it is presumed that pedestrians etc. in the vicinity may feel the noise the electric moving body generates too noisy. Alarm sound in reversed phase is generated to cancel out the noise the electric moving body generates, so that the noise the electric moving body generates is prevented from causing adverse effect on the ambient noise.

### Embodiment 3

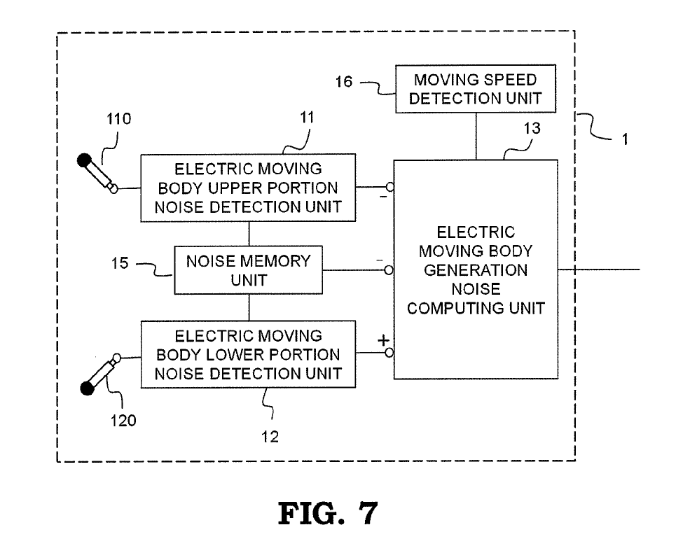

FIG. 6 is a block diagram showing a general configuration of an essential part of an electric moving body alarm sound control device according to Embodiment 3 of the present invention. In FIG. 6, the same reference numerals as those in FIG. 1 represent the same or corresponding parts. FIG. 6 shows only the essential part of the alarm sound control device according to this Embodiment. This Embodiment 3 is provided with an alarm sound switching unit 4C between the electric moving body noise level comparison determination unit 2 and alarm sound generation unit 4. During determination of the electric moving body noise level, generation of alarm sound is stopped by a signal from the alarm sound switching unit 40, the noise the electric moving body generates and noise generated in the ambience are detected, and then the electric moving body noise level comparison determination unit 2 carries out comparison and determination thereof.

When the alarm sound switching unit 40 is not provided, the alarm sound the sound-emitting unit 6 emits is mixed into both the electric moving body lower portion noise detection unit 12 and electric moving body upper portion noise detection unit 11; therefore, the noise the electric moving body generates by itself and the ambient noise need to be separated from the alarm sound and then computed. According to this Embodiment 3, since the alarm sound switching unit 40 is provided to control the generation of the alarm sound to stop only during the determination, the alarm sound is not mixed into signals detected by the electric moving body lower portion noise detection unit 12 and electric moving body upper portion noise detection unit 11, so that the signals can include only the noise the electric moving body generates by itself and ambient generation noise; therefore, the alarm sound does not need to be separated and then computed, whereby the configuration of the electric moving body noise level comparison determination unit 2 can be simplified.

### Embodiment 4

FIG. 7 is a block diagram showing a general configuration of an electric moving body noise detection unit of an electric moving body alarm sound control device according to Embodiment 4 of the present invention. In FIG. 7, the same reference numerals as those in FIG. 3 represent the same or corresponding parts. This Embodiment 4 is provided with a noise memory unit 15 that memorizes at least one of the signals detected by the electric moving body lower portion noise detection unit 12 and electric moving body upper portion noise detection unit 11, and a moving speed detection unit 16 that detects moving speed of the electric moving body. When the moving speed detection unit 16 detects that the electric moving body is in a pause, noise detected by the electric moving body lower portion noise detection unit 12 or electric moving body upper portion noise detection unit 11 is presumed to be completely ambient noise, and this noise is memorized in the noise memory unit 15. On the presumption that the ambient noise does not change so much during a time after the electric moving body begins moving from the pause until it moves for a predetermined time period, the electric moving body generation noise computing unit 13 computes the electric moving body generation noise level the electric moving body generates by itself from the detection signals detected by the electric moving body lower portion noise detection unit 12 and electric moving body upper portion noise detection unit 11 in motion.

By configuring as described above, the electric moving body generation noise level the electric moving body generates by itself can be computed more accurately.

### Embodiment 5

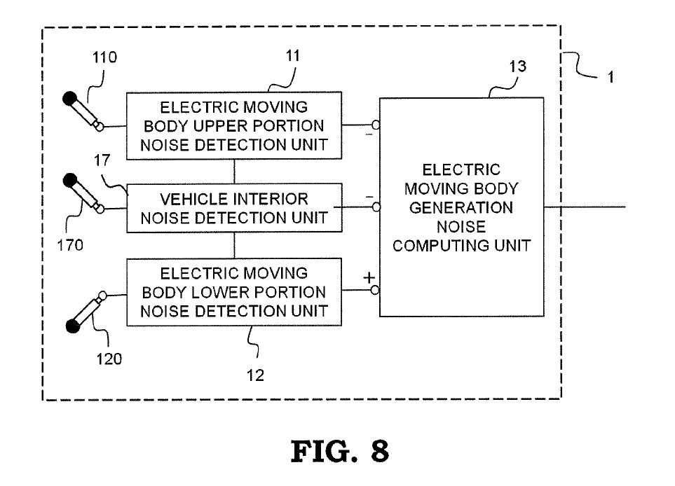

FIG. 8 is a block diagram showing a general configuration of the electric moving body noise detection unit 1 of an electric moving body alarm sound control device according to Embodiment 5 of the present invention. In FIG. 8, the same reference numerals as those in FIG. 3 represent the same or corresponding parts. This Embodiment 5 is provided with a vehicle interior noise detection unit 17 that detects vehicle interior noise by a vehicle interior noise detector 170, such as a microphone, installed in the vehicle interior. Taking into consideration conditions that the interior noise is mixed into the electric moving body generation noise and ambient noise at both the electric moving body lower portion noise detection unit 12 and the electric moving body upper portion noise detection unit 11, the electric moving body generation noise input in those three noise detectors is computed from three sorts of noise.

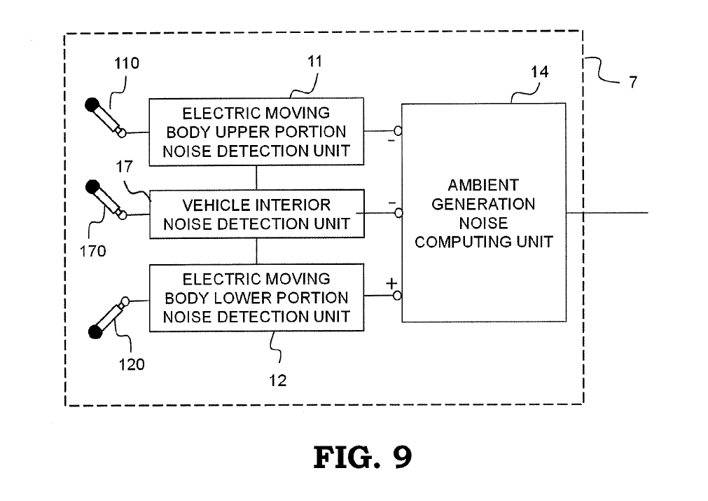

FIG. 9 is a block diagram showing a general configuration of the ambient noise detection unit 7 of the electric moving body alarm sound control device according to Embodiment 5 of this invention. In FIG. 9, the same reference numerals as those in FIG. 5 represent the same or corresponding parts. Also in FIG. 9 it is provided the vehicle interior noise detection unit 17 that detects noise in the vehicle interior by the vehicle interior noise detector 170, such as a microphone, installed in the vehicle interior; taking into consideration the conditions that the interior noise is mixed into the electric moving body generation noise and ambient noise at both the electric moving body lower portion noise detection unit 12 and the electric moving body upper portion noise detection unit 11, the ambient generation noise input in those three noise detectors is computed from the three sorts of noise.

By configuring as described above, the electric moving body generation noise level the electric moving body generates by itself and ambient generation noise level can be computed accurately, even when the vehicle interior noise level is high.

Moreover, still more noise detectors may be provided; noise the electric moving body generates by itself or noise generated in the ambience surrounding the electric moving body is computed by using detection signals detected by the plurality of noise detectors installed at different positions, whereby the noise the electric moving body generates by itself and noise generated in the ambience surrounding the electric moving body can be accurately detected with a simple configuration.

### Embodiment 6

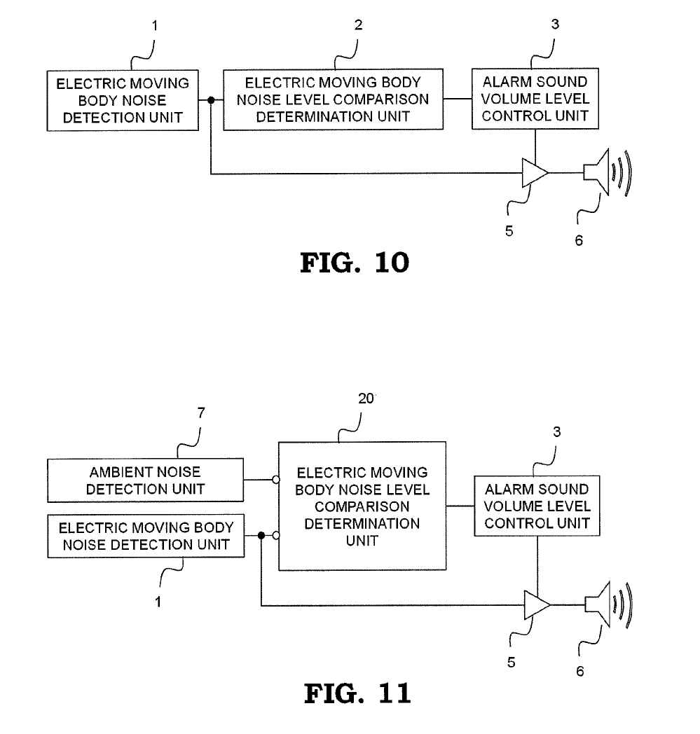

FIG. 10 is a block diagram showing a general configuration of an electric moving body alarm sound control device according to Embodiment 6 of the present invention. In FIG. 10, the same reference numerals as those in FIG. 1 represent the same or corresponding parts. In this Embodiment 6, the noise signal the electric moving body generates, which is the detection signal detected by the electric moving body noise detection unit 1, is input to the alarm sound amplifier 5 in place of that from the alarm sound generation unit 4 in Embodiment 1. By doing so, the alarm sound generation unit 4 can be eliminated, as well as unique sound inherent to the electric moving body can be generated.

FIG. 11 is a block diagram showing a general configuration of another electric moving body alarm sound control device according to Embodiment 6 of the present invention. In FIG. 11, the same reference numerals as those in FIG. 4 represent the same or corresponding parts. In this Embodiment 6, the noise signal the electric moving body generates, which is the detection signal detected by the electric moving body noise detection unit 1, is input to the alarm sound amplifier 5 in place of that from the alarm sound generation unit 4 in Embodiment 2. By doing so, the alarm sound generation unit can be eliminated, as well as unique sound inherent to the electric moving body can be generated.

### Embodiment 7

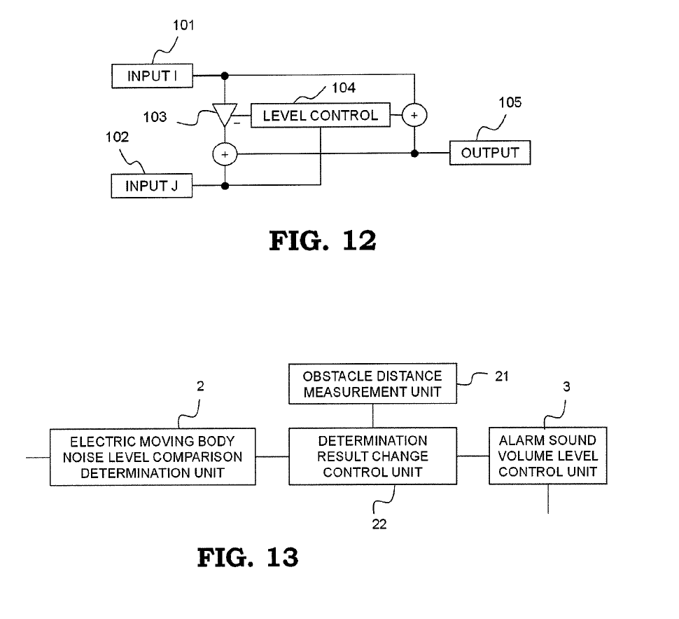

FIG. 12 is a block diagram showing a general configurational example of an essential part of an electric moving body alarm sound control device according to Embodiment 7 of the present invention. That is to say, it is a block diagram showing an example of computing units including the electric moving body generation noise computing unit 13 and ambient generation noise computing unit 14 in the foregoing embodiments. In FIG. 12, an input I 101 is, for example, the detection signal detected by the electric moving body upper portion noise detection unit 11 in the foregoing embodiments; an input J 102 is, for example, the detection signal detected by the electric moving body lower portion noise detection unit 12 in the foregoing embodiments. Moreover, let sound i be noise generated in the ambience, and sound j, noise the electric moving body generates by itself.

The input I includes the sound i and sound j with those mixed together; the sound i is dominant input and equation I=I+a*j. In addition, the input J includes the sound i and sound j with those mixed together; the sound j is dominant input and equation J=b*i+j is input, where a and b are predetermined constants in a fixed spatial field depending on microphone installation positions.

In order to derive only j from those two inputs, I and J

j=(J−b*I)/(1+a*b)

Therefore

j∝J−α*I

Then α is obtained, control takes place at a level control 104, and j is derived as an output 105.

Similarly, in order to derive only i

i=(I−a*J)/(1+a*b)

Therefore

i′I−β*J

Then β is obtained, control takes place at the level control 104, and i is derived as the output 105.

By configuring as described above, only the required sound can be derived from a mixture of multiple sorts of sound at the inputs. Using multiple stages of the above enables multiple inputs to be dealt with.

For example, as shown in Embodiment 5, when there are three inputs, I, J and K, as the input signals, that is, the detection signal detected by the electric moving body upper portion noise detection unit 11, the detection signal detected by electric moving body lower portion noise detection unit 12, and the detection signal detected by the vehicle interior noise detection unit 17, those are expressed by using predetermined constants of a to f in the fixed spatial field depending on the microphone installation positions as follows:

I=i+a*j+c*k

J=b*i+j+d*k

K=e*i+f*j+k

In order to derive only i from the three inputs, I, J and K

i=[(1−d*f)*I−(1−c*f)*J−−{c*(1−d*f)−d*(1−c*f)}*K]/{(1−c*e)−(1−c*f)(b−d*e)

Therefore

i∝I−α*J−γ*K

Then gains α and γ are obtained, and control takes place.

Next, in Tables 1 to 4 are shown comparison states at the electric moving body noise level comparison determination unit 2 and control states of the comparison results, when the alarm sound is controlled by using the noise the electric moving body generates by itself and ambient generation noise as derived above.

TABLE 1

| MOVING BODY | | |
|---|---|---|
| GENERATION | ARARM | AMPLIFICATION |
| NOISE | SOUND | AMOUNT |
| X < (Rx + Adj1*S) | ON | Sadj = Adj_a* (Rx − X) |
| X ≧ (Rx + Adj1*S) | OFF | Sadj = 0 |

TABLE 2

| MOVING BODY | | |
|---|---|---|
| GENERATION | ARARM | AMPLIFICATION |
| NOISE | SOUND | AMOUNT |
| X < (Rx + Adj1*S) | ON | Sadj = Adj_a* (Rx − X) |
| X ≧ (Rx + Adj1*S) | GENERATION | Sadj = Adj_a* (X − Rx) |
| | SOUND OF | |
| | REVERCED | |
| | PHASE | |

Tables 1 and 2 show examples, in which, as explained in Embodiment 1, determination is made at the electric moving body noise level comparison determination unit 2, by using the noise that is generated by the electric moving body itself and detected by the electric moving body noise detection unit 1. As shown in Tables 1 and 2, by using the volume of noise the electric moving body generates by itself, X, an electric moving body generation specified volume, which is a preset specified value, RX, a preset alarm sound volume, S, and an attenuation adjusting factor, Adj1, in a space from the alarm sound generation speaker, which is the sound-emitting unit 6, to the vehicle lower portion microphone, which is the vehicle lower portion noise detector 120, when inequality X<(RX+Adj1*S), the alarm sound is generated. At this moment, the amplified volume of alarm sound, Sadj, is controlled to become equality Sadj=Adj_a*(RX−X), by using the attenuation adjusting factor, Adj_a, in the space at a specified distance from the alarm sound generation speaker as shown in Table 1. In Table 1, the alarm sound is not generated when inequality X≦(RX+Adj1*S). At this moment, the volume of alarm sound is equation Sadj=0.

In Table 2, when inequality X≦(RX+Adj1*S), by using as the alarm sound the noise the electric moving body generates by itself explained in Embodiment 6, alarm sound in the reversed phase of this noise is generated, and the noise the electric moving body generates is canceled out at the position at the specified distance from the electric moving body, so that the noise from the electric moving body at the position is controlled to become a volume equivalent to the volume the electric moving body generates, equation X=(RX+Adj1*S). At this moment, the volume of adjusted alarm sound is made equation Sadj=Adj_a*(X−RX), by using the attenuation adjusting factor Adj_a of the phase-reversed alarm sound in the space at the specified distance from the alarm sound generation speaker, which is the sound-emitting unit 6.

TABLE 3

| MOVING BODY | | |
|---|---|---|
| GENERATION NOISE | | |
| — | | |
| AMBIENT | ARARM | AMPLIFICATION |
| GENERATION NOISE | SOUND | AMOUNT |
| Z < (Rz + Adj1*S) | ON | Sadj = Adj_a* (Rz − Z) |
| Z ≧ (Rz + Adj1*S) | OFF | Sadj = 0 |

TABLE 4

| MOVING BODY | | |
|---|---|---|
| GENERATION NOISE | | |
| — | | |
| AMBIENT | ARARM | AMPLIFICATION |
| GENERATION NOISE | SOUND | AMOUNT |
| Z < (Rz + Adj1*S) | ON | Sadj = Adj_a* (Rz − Z) |
| (Rz + Adj1*S) ≦ | OFF | Sadj = 0 |
| Z < (Rz2 + Adj1*S) | | |
| Z ≧ (Rz2 + Adj1*S) | GENERATION | Sadj = Adj_a* (X − Rx) |
| | SOUND OF | |
| | REVERCED | |
| | PHASE | |

Tables 3 and 4 show examples when the electric moving body noise level comparison determination unit 2 makes determination, as described in Embodiment 2, using the noise that is generated by the electric moving body itself and detected by the electric moving body noise detection unit 1 and the ambient generation noise detected by the ambient noise detection unit 7. As shown in Tables 3 and 4, by using a volume difference Z between the noise the electric moving body generates by itself and ambient generation noise, a specified volume difference i between the noise the electric moving body generates by itself, which is a preset specific volume, and the ambient generation noise, the volume of preset alarm sound S, and the attenuation adjusting factor Adj1 in the space from the alarm sound generation speaker, which is the sound-emitting unit 6, to the vehicle lower portion microphone, which is the vehicle lower portion noise detector 120, and the vehicle (upper) portion microphone, which is the vehicle upper portion noise detector 110, the first predetermined volume described in Embodiment 2 is specified as RZ+Adj1*S. When inequality Z<(RZ+Adj1*S), the alarm sound is generated. The amplified volume of alarm sound Sadj at this moment is controlled to become equation Sadj=Adj_a*(RZ−Z) by using the attenuation adjusting factor Adj_a in the space at the specified distance from the alarm sound generation speaker as shown in Tables 3 and 4.

In Table 3, the alarm sound is not generated when inequality Z≦(RZ+Adj1*S). At this moment, the volume of alarm sound is equation Sadj=0. In Table 4, a volume of RZ2+Adj1*S, which is greater than the first predetermined volume, is specified as the second predetermined volume described in Embodiment 2. When inequality (RZ+Adj1*S)≦Z<(RZ2+Adj1*S), the alarm sound is not generated. Furthermore, when inequality Z≧(RZ2+Adj1*S), by using as the alarm sound the noise the electric moving body generates by itself described in Embodiment 6, alarm sound in the reversed phase of this noise is generated. By generating the alarm sound in the reversed phase, the noise the electric moving body generates is canceled out at the position at the specified distance from the electric moving body. The noise from the electric moving body at the position is controlled to have a volume equivalent to the volume the electric moving body generates, equation X=(RX+Adj1*S), the same as that described in Table 2, for example. At this moment, the volume of alarm sound is made equation Sadj=Adj_a*(X−RX), by using the attenuation adjusting factor Adj_a of the phase-reversed alarm sound in the space at the specified distance from the alarm sound generation speaker.

### Embodiment 8

FIG. 13 is a block diagram showing a general configuration of an essential part of an electric moving body alarm sound control device according to Embodiment 8 of the present invention. In FIG. 13, the same reference numerals as those in FIG. 1 represent the same or corresponding parts. This Embodiment 8 shown in FIG. 13 is provided with an obstacle distance measurement unit 21 that measures distance to an obstacle. In addition, a determination result change control unit 22 is provided that changes the volume determined by the electric moving body noise level comparison determination unit 2 in such a way that the volume of sound reaching the obstacle becomes a sound volume estimated from the distance to the obstacle measured by the obstacle distance measurement unit 21, so as to tell the presence of the electric moving body to the obstacle without fail.

### Embodiment 9

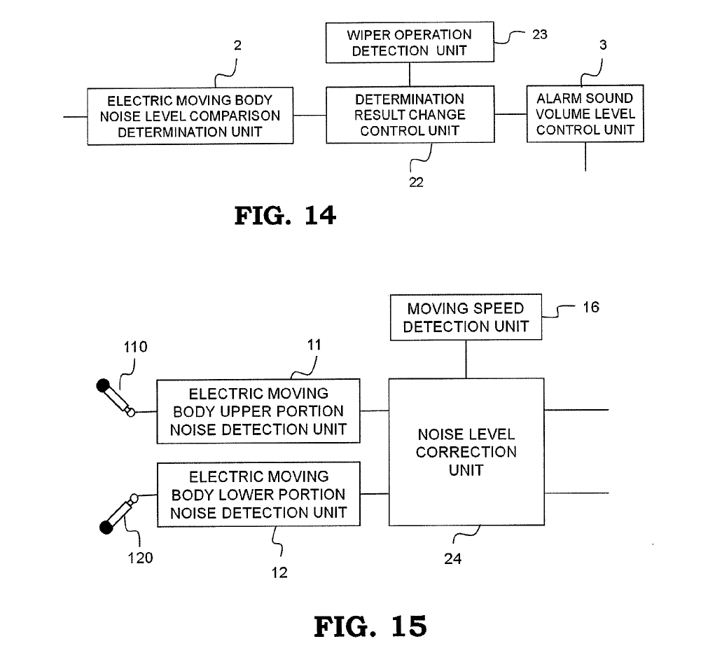

FIG. 14 is a block diagram showing a general configuration of an essential part of an electric moving body alarm sound control device according to Embodiment 9 of the present invention. In FIG. 14, the same reference numerals as those in FIG. 13 represent the same or corresponding parts. This Embodiment 9 shown in FIG. 14 is provided with a wiper operation detection unit 23 that detects wiper operation. When a wiper is detected in operation by the wiper operation detection unit 23, the determination result change control unit 22 changes the volume determined by the electric moving body noise level comparison determination unit 2 in such a way that an attenuation amount by rain of the noise the electric moving body generates is estimated, and the volume of noise reaching the obstacle is changed to become the specified volume, so as to tell the presence of the electric moving body to the obstacle without fail.

### Embodiment 10

FIG. 15 is a block diagram showing a general configuration of an essential part of another electric moving body alarm sound control device according to Embodiment 10 of the present invention. In FIG. 15, the same reference numerals as those in FIG. 3 and FIG. 5 represent the same or corresponding parts. This Embodiment 10 shown in FIG. 15 is provided with a moving speed detection unit 16 that detects speed of the electric moving body and a noise level correction unit 24. Wind noise picked up by the microphones, which are the vehicle upper portion noise detector 110 and vehicle lower portion noise detector 120, is estimated, noise levels output from the electric moving body upper portion noise detection unit 11 and electric moving body lower portion noise detection unit 12 in FIG. 3 and FIG. 5 are corrected by the noise level correction unit 24, and then the electric moving body noise and ambient noise described in the foregoing embodiments are computed. By configuring as above, the electric moving body noise and ambient noise can be obtained more accurately.

### DESCRIPTION OF THE REFERENCE NUMERALS

1: electric moving body noise detection unit
2, 20: electric moving body noise level comparison determination unit
3: alarm sound volume level control unit
4: alarm sound generation unit
5: alarm sound amplifier
6: sound-emitting unit
7: ambient noise detection unit
11: electric moving body upper portion noise detection unit
12: electric moving body lower portion noise detection unit
13: electric moving body generation noise computing unit
14: ambient generation noise computing unit
15: noise memory unit
16: moving speed detection unit
17: vehicle interior noise detection unit
21: obstacle distance measurement unit
22: determination result change control unit
23: wiper operation detection unit
24: noise level correction unit
40: alarm sound switching unit
110: vehicle upper portion noise detector
120: vehicle lower portion noise detector
170: vehicle interior noise detector

1. An electric moving body alarm sound control device that takes control of alarm sound emitted outside from a sound-emitting unit provided in an electric moving body that produces at least part of drive power by an electric motor, the alarm sound control device comprising:
an electric moving body noise detection unit that detects noise the electric moving body generates by itself;
an electric moving body noise level comparison determination unit that determines a noise level the electric moving body generates, based on a detection signal the electric moving body noise detection unit detects;
an alarm sound volume level control unit that takes control of the volume level of the alarm sound the sound-emitting unit emits, based on the determination result by the electric moving body noise level comparison determination unit;
an electric moving body upper portion noise detection unit that outputs a detection signal detected by a vehicle upper portion noise detector installed at an upper position of the electric moving body; and
an electric moving body lower portion noise detection unit that outputs a detection signal detected by a vehicle lower portion noise detector installed at a lower position of the electric moving body,
wherein the electric moving body noise detection unit includes an electric moving body generation noise computing unit that computes the noise the electric moving body generates by itself, using output from the electric moving body upper portion noise detection unit and output from the electric moving body lower portion noise detection unit.

2. (canceled)

3. (canceled)

4. An electric moving body alarm sound control device according to claim 1, further comprising a vehicle interior noise detection unit that outputs a detection signal detected by a vehicle interior noise detector that detects vehicle interior noise, wherein the electric moving body generation noise computing unit computes the noise the electric moving body generates by itself, using output from the electric moving body upper portion noise detection unit, output from the electric moving body lower portion noise detection unit, and output from the vehicle interior noise detection unit.

5. An electric moving body alarm sound control device according to claim 1, further comprising an ambient noise detection unit that detects noise generated in an ambience surrounding the electric moving body, wherein the electric moving body noise level comparison determination unit compares output from the electric moving body noise detection unit with output from the ambient noise detection unit, thereby determining a noise level the electric moving body generates.

6. An electric moving body alarm sound control device according to claim 5, wherein the ambient noise detection unit includes an ambient generation noise computing unit that computes the noise generated in the ambience, using detection signals detected by a plurality of noise detectors installed at different positions of the electric moving body.

7. An electric moving body alarm sound control device according to claim 6, wherein the ambient noise detection unit includes the ambient generation noise computing unit that computes the noise generated in the ambience surrounding the electric moving body, using output from the electric moving body upper portion noise detection unit, and output from the electric moving body lower portion noise detection unit.

8. An electric moving body alarm sound control device according to claim 6, wherein the ambient noise detection unit includes the ambient generation noise computing unit that computes the noise generated in the ambience surrounding the electric moving body, using output from the electric moving body upper portion noise detection unit, output from the electric moving body lower portion noise detection unit, and output from a vehicle interior noise detection unit that outputs a detection signal detected by a vehicle interior noise detector that detects vehicle interior noise.

9. An electric moving body alarm sound control device according to claim 1, wherein the vehicle upper portion noise detector is installed so as to detect noise outside a ceiling of the electric moving body.

10. An electric moving body alarm sound control device according to claim 1, wherein the alarm sound is paused, and the electric moving body generation noise computing unit computes the noise the electric moving body generates by itself, using output from the electric moving body upper portion noise detection unit and output from the electric moving body lower portion noise detection unit during the pause of the alarm sound.

11. An electric moving body alarm sound control device according to claim 6, wherein emission of the alarm sound is paused, and the ambient generation noise computing unit computes using output from the noise detection unit during the pause of the alarm sound emission.

12. An electric moving body alarm sound control device according to claim 1, wherein an output signal from the electric moving body noise detection unit is utilized as a sound source for the alarm sound.

13. An electric moving body alarm sound control device according to claim 1, further comprising:
an obstacle distance measurement unit that measures distance to an obstacle in the vicinity of the electric moving body; and
a determination result change control unit that changes the determination result by the electric moving body noise level comparison determination unit, based on output from the obstacle distance measurement unit.

14. An electric moving body alarm sound control device according to claim 1, further comprising:
a wiper operation detection unit that detects operation of a wiper of the electric moving body; and
a determination result change control unit that changes the determination result by the electric moving body noise level comparison determination unit, based on output from the wiper operation detection unit.

15. An electric moving body alarm sound control device according to claim 1, further comprising:
a moving speed detection unit that detects moving speed of the electric moving body; and
a noise level correction unit that corrects the detection signals detected by the noise detectors, based on output from the moving speed detection unit.
